(19) United States
(12) Patent Application Publication
(10) Pub. No.: US 2026/0128684 A1
(43) Pub. Date: May 7, 2026

(54) BI-DIRECTIONAL FIELD EFFECT TRANSISTOR (BiDFET)-BASED AC-DC POWER CONVERTER

(71) Applicant: North Carolina State University, Raleigh, NC (US)

(72) Inventors: Suyash Sushilkumar Shah, Raleigh, NC (US); Subhashish Bhattacharya, Raleigh, NC (US)

(21) Appl. No.: 19/119,452

(22) PCT Filed: Oct. 9, 2023
(86) PCT No.: PCT/US2023/076351

§ 371 Date: Apr. 9, 2025

Related U.S. Application Data
(60) Provisional application No. 63/414,510, filed on Oct. 9, 2022.

(51) Int. Cl. H02M 7/5387; H02M 1/088; H02M 1/14; H02M 1/32

(52) U.S. Cl. CPC H02M 7/5387; H02M 1/088; H02M 1/14; H02M 1/32

(57) ABSTRACT

Various examples are provided related to AC-DC power conversion. In one example, a power converter includes a first bridge circuit including a plurality of bidirectional field effect transistor (BiDFET) devices; a second bridge circuit; a link coupling the first and second bridge circuits; and control circuitry to control operation of the plurality of BiDFET devices of the first bridge circuit and switching devices of the second bridge circuit. The control circuitry includes a gate-driver to provide isolated driving signals to each BiDFET device that cause continuous conductance of a first switch of the BiDFET device though a corresponding switching period and modulates a second switch of the BiDFET device through the corresponding switching period.

### CROSS REFERENCE TO RELATED APPLICATIONS

This application claims priority to, and the benefit of, co-pending U.S. provisional application entitled “Bi-Directional Field Effect Transistor (BiDFET)-Based AC-DC Power Converter” having Ser. No. 63/414,510, filed Oct. 9, 2022, which is hereby incorporated by reference in its entirety.

### STATEMENT REGARDING FEDERALLY SPONSORED RESEARCH OR DEVELOPMENT

This invention was made with government support under grant number DE-EE0008345 awarded by the U.S. Department of Energy—Office of Energy Efficiency and Renewable Energy. The government has certain rights in the invention.

### SUMMARY

Aspects of the present disclosure are related to AC-DC power conversion. In one aspect, among others, a power converter comprises a first bridge circuit comprising a plurality of bidirectional field effect transistor (BiDFET) devices configured for four quadrant operation; a second bridge circuit comprising a plurality of switching devices; a link coupling the first and second bridge circuits; and control circuitry configured to control operation of the plurality of BiDFET devices of the first bridge circuit and the plurality of switching devices of the second bridge circuit, where the control circuitry comprises a gate-driver configured to provide two isolated driving signals to each BiDFET device, the isolated driving signals causing continuous conductance of a first switch of the BiDFET device though a corresponding switching period and modulates a second switch of the BiDFET device through the corresponding switching period. In one or more aspects, the plurality of BiDFET devices can comprise monolithic SiC BiDFETs.

In one or more aspects, the plurality of BiDFET devices can comprise back-to-back transistors coupled with a common source or a common drain. The first bridge circuit can be a three-phase bridge circuit or a single-phase bridge circuit. The control circuitry can comprise interlocking circuitry configured to coordinate switching of the plurality of BiDFET devices preventing capacitor voltage shorting or inductor current breaking. The interlocking circuitry can be configured to coordinate withdrawal or supply of gate-pulses during a trip in response to a fault condition. The interlocking circuitry can coordinate withdrawal of the gate-pulses from the plurality of BiDFET devices to trip the power converter. The trip can be implemented without shorting the capacitor terminals or opening non-zero inductor current.

In various aspects, the control circuitry can comprise short-circuit fault protection configured to detect a short-circuit condition and adjust operation of the plurality of BiDFET devices to remove the short-circuit condition. The power converter can be configured for bidirectional power flow via the first and second bridge circuits. The power converter can be utilized to control power flow of an energy storage system. The power converter can be utilized to control power flow of a photovoltaic (PV) solar cell in a solar PV energy application. Modulation of the second switch can be based upon polarity of a blocking voltage when it is turned-off. The gate-driver can be configured to independently control the two isolated driving signals. The gate-driver can comprise digital isolators for the isolated driving signals. The power converter can comprise a second-order capacitor-inductor (CL) filter at an output of the first bridge circuit, the second-order CL filter configured to attenuate switching frequency harmonics generated by the power converter. The second-order CL filter can comprise a parallel resistor-capacitor (RC) damping branch. The second-order CL filter can maintain a total harmonic distortion of 5% or less.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BACKGROUND

The declining capital and operational costs of solar power has resulted in its rapid adoption in the commercial and industrial energy generation. The 2020 Annual Technology Baseline data from National Renewable Energy Laboratory (NREL) suggests that with ‘moderate’ technology outlook, the levelized cost of energy per MWh for commercial, distributed solar in cities like Los Angeles will reduce from the baseline of US$ 70 to US$32 in 2030.

A key component in distributed solar installed for commercial-industrial energy generation is the power conversion system to interface with the utility grid at standard nominal voltages. For low voltage systems in North America, these are 208Y/120 V, 240Δ/120 V and 480Y/277 V. Among these, a common single-phase voltage level available for high power loads is a) the 277 V level derived from 3-phase, 4-wire, 480 V system, or b) the 240 V level derived from 240 V-Δ system. High power loads include lighting devices such as fluorescent and high-pressure vapor lamps, heating appliances, unitary air conditioners and heat pumps, electric furnaces, motor compressors and comfort heating.

A mandatory requirement from the article 690 of the NEC is system grounding and fault monitoring on the photovoltaic (PV) side. In single-phase solar power converter systems, it translates to grounding on its DC as well as its AC port. Therefore, in the US, most modern single-phase grid-connected solar converter topologies comprise of high frequency transformers for galvanic isolation.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram illustrating an example of a single-phase AC/DC DAB circuit using monolithic 1200 V SiC Bi-directional FETs (BiDFETs), in accordance with various embodiments of the present disclosure.

FIGS. 2A-2E illustrate examples of fabrication, packaging and characteristics of a BiDFET, in accordance with various embodiments of the present disclosure.

FIG. 3 an example of, in accordance with various embodiments of the present disclosure.

FIG. 4 is a flow chart illustrating an example of an optimization method, in accordance with various embodiments of the present disclosure.

FIGS. 5A and 5B illustrate examples of frequency response and power loss of a (capacitor-inductor) CL-filter and damping resistor, R_{f}, in accordance with various embodiments of the present disclosure.

FIG. 6 is an image of an AC/DC DAB converter based on monolithic SiC-BiDFET, in accordance with various embodiments of the present disclosure.

FIGS. 7A and 7B illustrate examples of operating waveforms of the AC/DC DAB converter of FIG. 6, in accordance with various embodiments of the present disclosure.

FIGS. 8A and 8B illustrate examples of power factor and current THD of the AC/DC DAB converter of FIG. 6, in accordance with various embodiments of the present disclosure

FIG. 9 illustrates examples of overall input to output port efficiency, semiconductor efficiency and estimated loss distribution at different rates of PV generation, in accordance with various embodiments of the present disclosure.

FIGS. 10A-10C illustrate examples of single-phase and three-phase power circuit configurations comprising four-quadrant switches, in accordance with various embodiments of the present disclosure.

FIG. 11 is a schematic diagram illustrating an example of a three-phase AC/DC DAB circuit using BiDFETs, in accordance with various embodiments of the present disclosure.

FIGS. 12-14 are schematic diagrams illustrating examples of converter circuitry, in accordance with various embodiments of the present disclosure.

FIGS. 15 and 16 are schematic diagrams illustrating examples of gate driver circuitry, in accordance with various embodiments of the present disclosure.

FIG. 17 illustrates an example of a control diagram for a single-phase AC DC DAB, in accordance with various embodiments of the present disclosure.

### DETAILED DESCRIPTION

Disclosed herein are various examples related to AC-DC power conversion. A single-phase AC/DC dual active bridge (DAB) converter is considered for supplying, e.g., solar generated power to the low voltage distribution grid. The topology can provide galvanic isolation and, if appropriately modulated, soft-switching capability across the operating load range and line cycle voltage. Reference will now be made in detail to the description of the embodiments as illustrated in the drawings, wherein like reference numbers indicate like parts throughout the several views.

The AC/DC DAB converter can comprise two full-bridge circuits generating high frequency AC square-wave voltage across a transformer-inductor arrangement. One version of the AC/DC DAB rectifier can involve a diode bridge (or synchronous) rectifier as a front-end system, followed by a DAB DC/DC converter. The front-end rectifier folds the bipolar AC grid voltage to a unipolar rectified AC voltage. The topology may not be feasible for the inverter operation. The second version of the AC/DC DAB converter that allows rectifier/inverter operation uses four quadrant power semiconductor (4-QPS) switches. These devices can block voltage and carry current in either direction. The converter and may be constructed using commercially available discrete semiconductor devices. Alternatively, reverse-blocking IGBTs may also be utilized as 4-QPS devices.

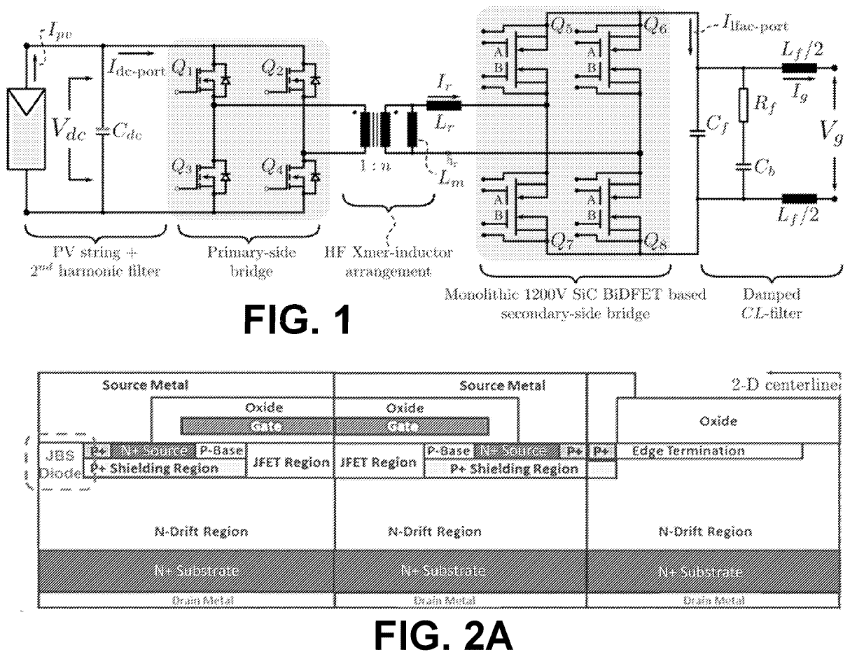

In this disclosure, the AC/DC DAB converter can be implemented using a 1200 V SiC-based monolithic bidirectional FET (BiDFET), which are described in, e.g., U.S. Pat. Nos. 10,804,393, 10,355,132, and 11,276,779, all of which are hereby incorporated by reference in their entireties. FIG. 1 is a schematic diagram illustrating an example of a single-phase AC/DC DAB circuit using the monolithic 1200 V SiC-BiDFETs. The four-terminal 1200 V SiC-BiDFET has a pair of gate and source terminals for each of the constituent FETs. It can be fabricated as a single die at, e.g., a commercial foundry (X-FAB) using an engineered process. The performance characterization data for the switching and conduction of 1200 V SiC-BiDFET up to 800 V, 20 A has been reported. The monolithic device can reduce the semiconductor component count and bond-wire sets, thereby improving the reliability of the grid-connected solar power converter system.

An optimization procedure is established to design an AC/DC DAB converter. The advanced modulation schemes developed for the DAB DC/DC converter can also be applied to its AC/DC version for optimal operation. In this disclosure, a method to design the AC/DC DAB converter is proposed, that includes all its modulation strategies and operating modes. The design may be optimized for minimum RMS (root mean square) current, minimum transformer VA rating or other objective function.

Further, the calculation reported in the literature for harmonic current at its AC and DC ports is mode-dependent; it also does not encompass the complete operating range. Therefore, an algorithm based on a singular, explicit model is proposed to compute the harmonic currents at its DC and grid-side AC ports. The proposed model is also used in the design of the respective filters.

The resultant solution of the design optimization procedure can be implemented in different variations of AC/DC DAB converter such as, e.g.: a) line frequency rectifier followed by DC/DC DAB converter, and b) single-stage converter comprising of four quadrant power semiconductor (4-QPS) devices. Considering the application of solar power converter system, a SiC-BiDFET based AC/DC DAB converter hardware prototype was developed based on the optimized design. The experimental results at full power, input DC and grid AC voltages of 2.3 kW, 400 V and 277 VRMS are presented. In addition, the total harmonic distortion (THD) in grid-side current at full-load and efficiency of the system throughout the operating load range are also presented.

4-QPS devices such as monolithic silicon-carbide based BiDFET are popular for several applications such as:
Motor drive applications using current source inverters (CSI) and direct AC-AC power conversion.
Solid-state transformers based on direct AC-AC conversion.
Grid integrated PV solar converters.
Data-center power supplies.
Wind power applications.
EV chargers.
Grid integrated Battery Energy Storage Systems (BESS).
   The 4-QPS devices can be utilized within converter settings to safely and efficiently exploit its advantage of bidirectional voltage blocking and bidirectional current carrying capability. A converter structure is disclosed that can be used to generate high frequency AC voltage/current from any DC/low frequency unipolar/bipolar voltage/current. It may also be used to generate DC/low frequency unipolar/bipolar voltage/current from a high frequency AC voltage/current. In addition, the bridge can control the power factor and total harmonic distortion on the DC/low frequency side.

The fabrication, packaging and characterization of an engineered 1200 V SiC-BiDFET is briefly described. The basic operation and modulation strategies of the AC/DC DAB converter is reviewed, and the expressions of switching instant and RMS currents as well as power transfer from the DC/DC DAB converter extended to its AC/DC version. The optimization problem is formulated including the definition of design space, feasible objective functions and constraints. The design solution derived using proposed strategy is also compared against the conventional strategy in this section. An algorithm to compute the harmonic currents at the AC and DC ports of the converter and the respective filter design strategies are presented. Experimental results on a 2.3 kW hardware prototype are also presented to verify the proposed design.

### 1200 V SiC Bidirectional Field Effect Transistor (BiDFET)

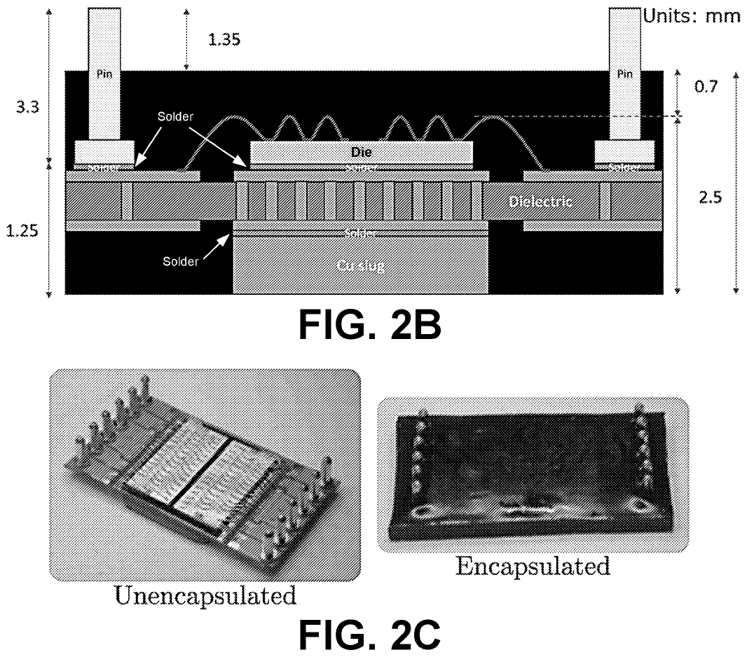

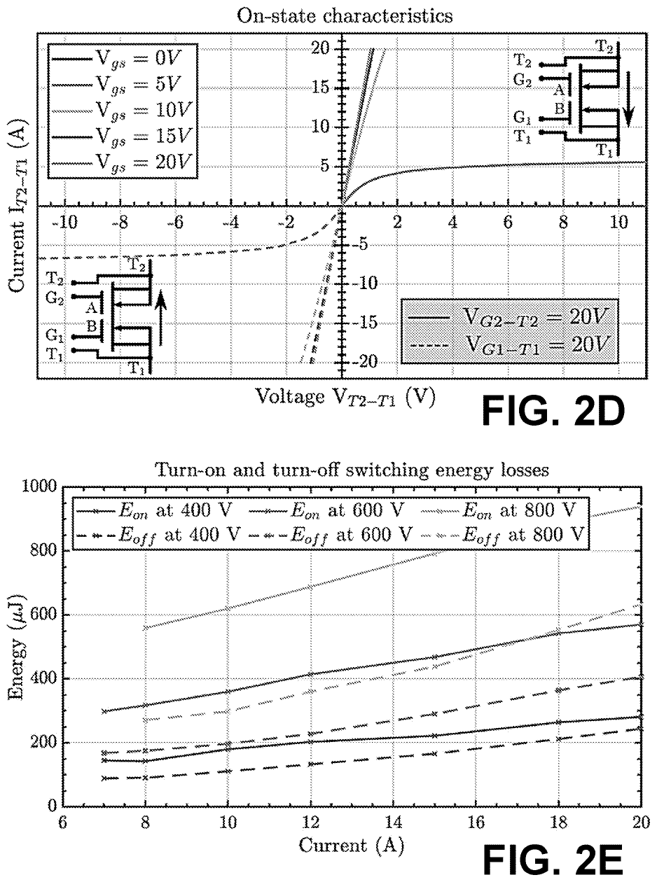

Fabrication. The four terminal monolithic 4H—SiC 1200 V BiDFET was fabricated at the six-inch commercial foundry, X-FAB. FIG. 2A illustrates an example of a 2-D centerline cross-section of the die for one of the integrated JBSFETs (MOSFETs with integrated Schottky JBS anti-parallel diodes). The fabricated BiDFET die has a large chip area of approximately 1.1 cm² with 0.45 cm² of active area for each internal JBSFET. The design includes two gate-pads for each JBSFET. The die demonstrated a low on-state resistance of 46 mΩ, threshold voltage of 1.73 V, transconductance of 17 S, and reverse transfer capacitance of 55 pF. Further details on the fabrication process of the BiDFET can be found in “Monolithic 4-Terminal 1.2 kV/20 A 4H—SiC Bi-Directional Field Effect Transistor (BiDFET) with Integrated JBS Diodes” by K. Han et al. (32nd International Symposium on Power Semiconductor Devices and ICs (ISPSD), September 2020, pp. 242-245).

Packaging. The packaging of the 1200 V BiDFET die uses organic aminates such as, e.g., a flex-PCB or substrate made of polyimide material. FIG. 2B illustrates an example of the packaging layer stack of the fabricated BiDFET module. The package layer stack was designed to provide twelve pin-outs: a pair of gate and Kelvin source connections for each internal JBSFET, and two pins each for the current carrying terminals of the device. FIG. 2C shows images of the un-encapsulated module with the BiDFET die and encapsulated module with 12 pin-outs. The BiDFET bare-die and its terminals were encapsulated in a 24.5×14.5×3.2 mm³ frame. The copper slug, electrically connected to the common-drain of the BiDFET, is attached to transfer the heat generated within the die to the heat sink. Further details on the packaging of the 1200 V SiC-BiDFET can be found in “Packaging Development for a 1200V SiC BiDFET Switch Using Highly Thermally Conductive Organic Epoxy Laminate” by U. Mehrotra et al. (32nd International Symposium on Power Semiconductor Devices and ICs (ISPSD), September 2020, pp. 396-399).

Characterization. The fabricated and packaged 1200 V SiC-BiDFET was characterized for its static and dynamic behavior. The static characterization, which was conducted using a curve tracer, measured parameters such as on-state resistance, transconductance and breakdown voltage. In addition, dynamic characterization was conducted with a BiDFET phase leg configured for clamped inductive switching test at a DC link voltage of 800 V, on-state current of 20 A, and a gate resistance of 10Ω. The measured on-state characteristics of the BiDFET device was symmetrical in the first and third quadrant as shown in FIG. 2D. The on-state resistance is 46 mΩ at 10 A and 20 V gate bias. Further, the loss data during the turn-on and turn-off of the device derived from the clamped inductive switching test were plotted as illustrated in FIG. 2E, which shows measured turn-on, turn-off losses at different currents and blocking voltages. Additional details regarding device characterization can be found in “Switching Characteristics of a 1.2 kV, 50 m SiC Monolithic Bidirectional Field Effect Transistor (BiDFET) with Integrated JBS Diodes” by A. Kanale et al. (IEEE Applied Power Electronics Conference and Exposition (APEC), June 2021, pp. 1267-1274).

### Basic Operation and Steady-State Model of the AC/DC Dab Converter

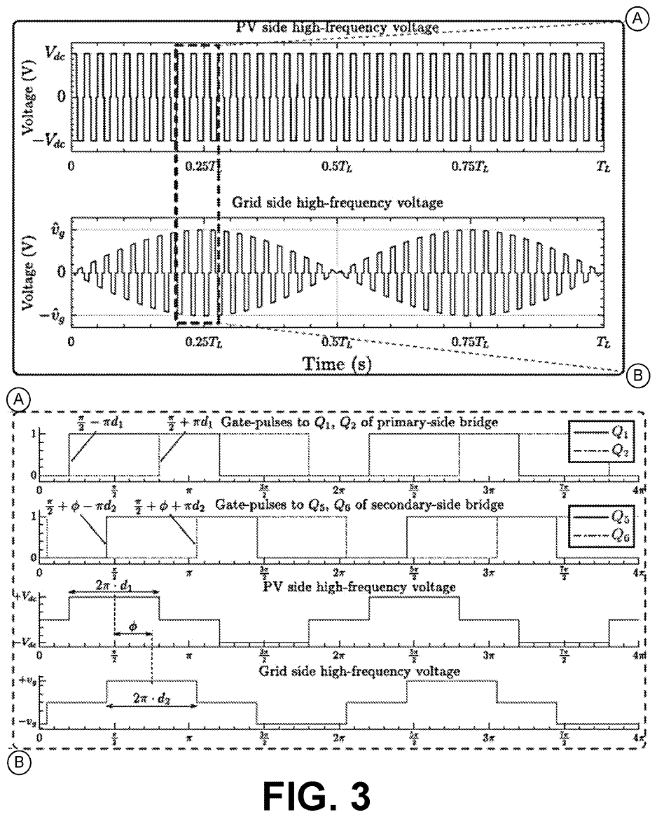

The basic operation of the AC/DC DAB converter is similar to that of its DC/DC version. The two full-bridge circuits of the converter generate square or quasi-square wave AC voltages across the transformer-inductor arrangement. Depending on the adopted modulation strategy, the power transfer between the input and output terminals is regulated through three control variables: the duty-ratios (d₁, d₂) of the high frequency AC voltages and the phase-shift angle (φ) between them. FIG. 3 illustrates representative high frequency voltage waveform of the single-phase AC/DC DAB converter at an operating point on the line frequency cycle. T_{L} is the period of the AC grid voltage. The converter is distinct in its ability to generate bipolar voltage at its grid-side terminals. Depending on the grid-voltage polarity, one constituent FET in the monolithic BiDFET modulates while the second FET conducts throughout the switching period.

Average power over switching period. The switching frequency of the converter is large compared to the grid frequency. Therefore, the average power over the switching period of the converter is approximately equal to the instantaneous power, Pᵢₙₛₜ, on the AC line cycle. It is derived in Eq. (1) through a modeling strategy that uses superposition of multiple circuits. The variables W, X, Y and Z are expressed in Eq. (3) as linear combinations of the duty-ratios (d₁, d₂) of the high frequency AC voltages and the phase-shift angle (φ) between them.

$${P}_{inst} = \frac{N \vert {v}_{g} \vert {V}_{d c}}{{ω}_{s} {L}_{r}} f ( ϕ , {d}_{1} , {d}_{2} ) \qquad ( 1 )$$

$$f ( ϕ , {d}_{1} , {d}_{2} ) = \frac{1}{4} [ - W ( 1 - \frac{\vert W \vert}{π} ) + X ( 1 - \frac{\vert X \vert}{π} ) - Y ( 1 - \frac{\vert Y \vert}{π} ) + Z ( 1 - \frac{\vert Z \vert}{π} ) ] \qquad ( 2 )$$

$${W}_{1} = \{ \begin{matrix}W , & if 0 \leq W < π \\ π - W , & if π \leq W \leq \frac{3 π}{2}\end{matrix} \qquad ( 3 )$$

$$W = ϕ + π {d}_{1} + π {d}_{2} ; X = ϕ + π {d}_{1} - π {d}_{2}$$

$$Y = ϕ - π {d}_{1} - π {d}_{2} ; Z = ϕ - π {d}_{1} + π {d}_{2}$$

where N is the transformer turns-ratio, v_{g} is the AC grid voltage, V_{dc} is the DC voltage, ωₛ is the switching frequency, and L, is the series inductance.

High frequency AC port currents. The principle of superposition may also be used in a different manner to derive the high frequency AC port currents. In Table 1, the transformer current at the semiconductor device turn-on instants referred to the grid-side are derived in terms of phase-angles of the switching instants (A, B, C, D), input to output voltage gain (M) and scaling factor (K) for the positive half-cycle. For the negative half-cycle, the sign of currents in Table I is reversed as its modulation is also 180° out-of-phase. The high frequency AC port RMS currents may also be calculated using the algorithm in “Exact Solution of ZVS Boundaries and AC-Port Currents in Dual Active Bridge Type DC-DC Converters” by S. S. Shah et al. (IEEE Transactions on Power Electronics, vol. 34, no. 6, pp. 5043-5047, June 2019).

$$A = \frac{π}{2} - π {d}_{1} ; B = \frac{π}{2} + π {d}_{1} \qquad ( 4 )$$

$$C = \frac{π}{2} + ϕ - π {d}_{2} ; D = \frac{π}{2} = ϕ + π {d}_{2}$$

$$M = \frac{\vert {v}_{g} \vert}{{NV}_{d c}} ; K = \frac{1}{2} \frac{{NV}_{d c}}{{ω}_{s} {L}_{r}}$$

TABLE I
High frequency transformer current at device turn-on
instants referred to the AC grid side (v_{g} ≥ 0).

| Current | Expressions |
|---|---|
| I_{Q1} | +K[M(π − \|C − A\| − \|D − π − A\|) − \|B − A\|] |
| I_{Q2} | −K[M(π − \|D − B\| − \|C − B + π\|) − \|B − A\|] |
| I_{Q5} | −K[π − \|C − A\| − \|C − B + π\| − M\|D − C\|] |
| I_{Q6} | +K[π − \|D − B\| − \|D − π − A\| − M\|D − C\|] |

where I_{Q1}, I_{Q2}, I_{Q5} and I_{Q6} are semiconductor currents at turn-on instants.

### Formulating the Optimization Problem

The single-phase AC/DC DAB converter was specified to transfer 2.3 kW of power from a nominal input DC voltage of 400 V to the 277 V_{RMS} grid. The algorithm to optimize the design of the converter will now be presented. The design space comprises transformer turns-ratio, N, and series inductance, Lᵣ. The switching frequency is fixed for ease of understanding but may be included as a design variable to trade-off the size of passive components with efficiency.

Design space and control variable limits. The design limits (lower bound and upper bound) for the transformer turns-ratio (N_{lb}, N_{ub}) are defined by the grid and DC voltages, i.e., N∈[0.01V_{g,pk}/V_{dc}, 10V_{g,pk}/V_{dc}], where V_{g,pk} is the peak grid voltage. The design limits of the inductor (lower bound and upper bound) are determined in Eq. (5) using specified limits on power transfer, input voltage, grid voltage and control variables (φ∈[3.6°, 90° ], d₁, d₂∈[0.01, 0.5]).

$${L}_{r , l b} = \frac{{N}_{l b} ( 0.01 {V}_{g , p k} ) {V}_{d c}}{{ω}_{s} {P}_{o , m i n}} f ( {ϕ}_{m i n} , {d}_{1 , m i n} , {d}_{2 , m i n} ) \qquad ( 5 )$$

$${L}_{r , ub} = \frac{{N}_{ub} {V}_{g , p k} {V}_{d c}}{{ω}_{s} ( 2 {P}_{o , rated} )} f ( {ϕ}_{m ax} , {d}_{1 , m ax} , {d}_{2 , m ax} )$$

where P_{o,rated} is the rated output power, and (φₘᵢₙ, d_{1,min}, d_{2,min}) and (φₘₐₓ, d_{1,max}, d_{2,max}) are the minimum and maximum phase shift angle and duty-ratios of the high frequency AC voltages, respectively.

f(φ,d₁,d₂) is expressed in Eq. (2). The maximum instantaneous power transfer in the single-phase converter is equal to twice the rated power, P_{o,rated}. The minimum instantaneous power transfer occurs near the zero crossing of the grid voltage; it is fixed at 0.2% of the rated power occurring at 1% of the peak AC voltage. It is ensured that at the design limits, specified instantaneous power transfer is possible at all points on the AC line voltage half-cycle. The limits on transformer turn-ratio (N) and inductor design (Lᵣ) are set, respectively, at [0.1,10] and [0.01 μH, 830 μH].

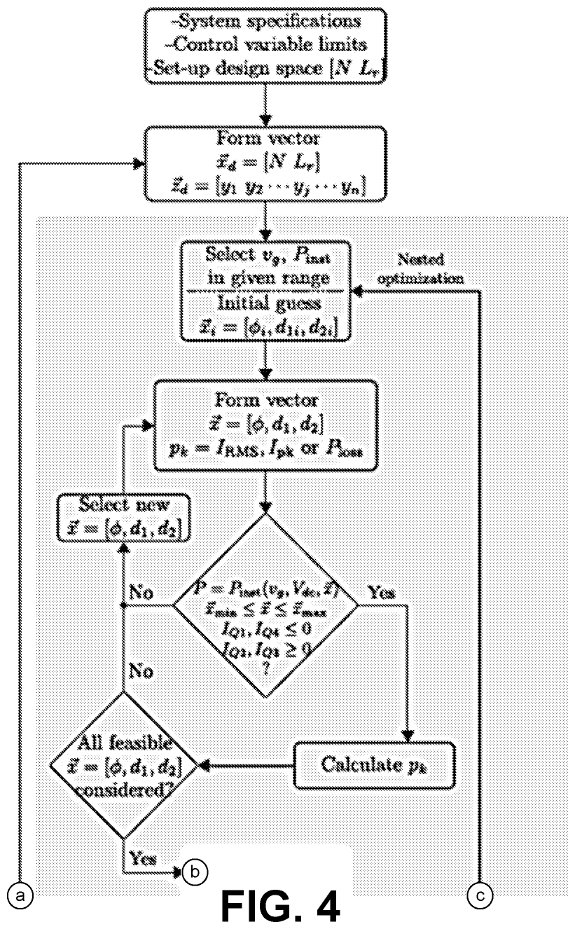

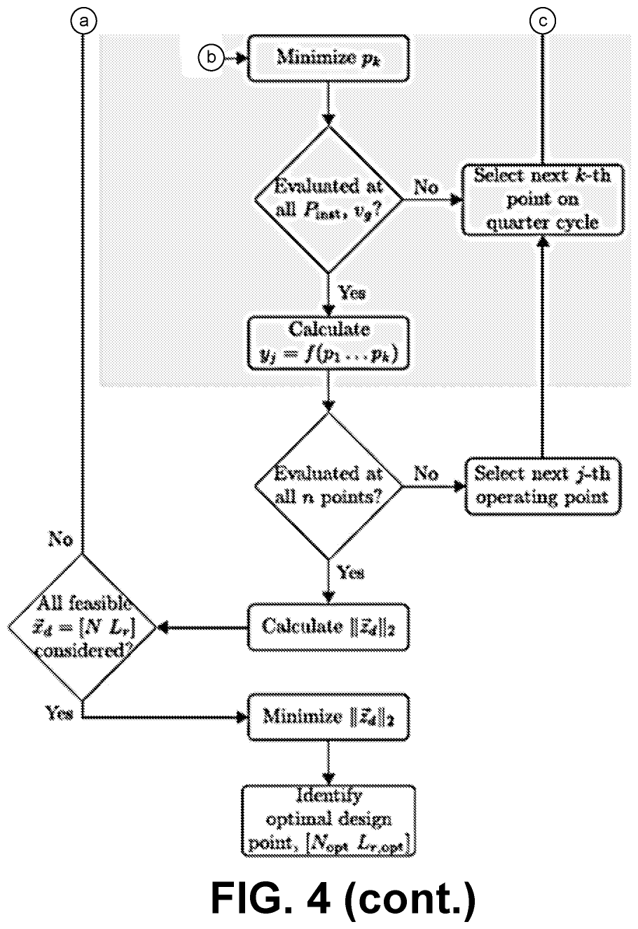

Setting up the optimization problem. Consider the system specifications described previously, including the limits on design space vector (\vec{x}_{d}=[N Lᵣ]) and control variables (\vec{x}=[φ d₁ d₂]). The parameters are fed into an optimization algorithm. FIG. 4 is a flow chart illustrating an example of the optimization algorithm.
1) Consider a vector \vec{z}_{d} comprising of elements yⱼ. yⱼ is the quantity optimized for the j-th operating point, where j=1, 2, . . . , n. It may be the peak current, RMS current, estimated efficiency, transformer VA rating or combined total VA rating (as defined later).
2) For each design point, [N Lᵣ], the nested optimization process is followed:
   a) The grid voltage is quarter-wave symmetrical. Therefore, divide the first quarter of the positive half-cycle of grid voltage into m operating points defined by v_{g} and Pᵢₙₛₜ.
   b) Initialize the optimization with \vec{x}ᵢ=[φᵢ d₁ᵢ d₂ᵢ].
   c) The quantity pₖ is optimized for the k-th point on the quarter-cycle of the AC voltage by varying a vector, z, of parameters [φ d₁ d₂] subject to constraints defined later.
   d) For the j-th operating point, the optimized quantities p₁, . . . , pₘ can be collected and can be further treated in accordance to their type to derive an overall optimized quantity, yⱼ=f(p₁, . . . , pₘ).
3) The aforementioned nested process can be repeated for all feasible design points to minimize the Euclidean norm, ∥\vec{z}_{d}∥₂. The optimal design point can, thus, be identified.
   Proposed objective functions.
1) Minimum combined total VA rating (Design 1): The AC/DC DAB converter transfers active power through the high frequency AC link. Therefore, circulating non-useful power is also present on both sides of the high frequency transformer inductor arrangement. The RMS voltages and currents at the high frequency AC link determine the sizes of the core and winding in this arrangement, respectively. However, the maximum voltage and current may not appear at a concurrent operating point. The total apparent power combined for the two sides of the AC link, therefore, is calculated in Eq. (6). Note that k is one of m points on the quarter-wave of the AC line cycle, whereas j is one of n operating points (operating points may mean varying load, line or DC voltage).

$${p}_{k} = {I}_{RM S , k} \qquad ( 6 )$$

$${y}_{j} = ( {max}_{k = 1}^{m} ( {NV}_{i n , j} \sqrt{2 {d}_{1 , k}} ) + {max}_{k = 1}^{m} ( {v}_{g , k} \sqrt{2 {d}_{2 , k}} ) ) \cdot {‖ {\vec{p}}_{k} ‖}_{2}$$

$${\vec{z}}_{d} = {max}_{j = 1}^{n} ( {y}_{j} )$$

where I_{RMS,k} is the RMS current at k and Vᵢₙ is the input voltage.
2) Minimum RMS current rating (Design 2): The largest proportion of loss in AC/DC DAB converter can be attributed to the conduction and switching losses in the system. If ZVS or near-ZVS is assured through constraints, minimizing the conduction loss can improve efficiency while also reducing the winding size of the high frequency AC link. Therefore, the objective function is defined in Eq. (7) to minimize the RMS currents on both sides of the transformer.

$${p}_{k} = {I}_{R MS , k} \qquad ( 7 )$$

$${y}_{j} = {\sum }_{k = 1}^{m} \sqrt{{p}_{k}^{2} ( 1 + {N}^{2} )} = {‖ {p}_{1} … {p}_{n} N {p}_{1} … N {p}_{n} ‖}_{2}$$

$${\vec{z}}_{d} = [ \begin{matrix}{y}_{1} & {y}_{2} & … & {y}_{n}\end{matrix} ]$$

Constraints on the optimization problem. This section lists the constraints not related to the design space (\vec{x}_{d}=[N Lᵣ]) described previously. These are related to operating power transfer, limits on control variables and conditions for soft-switched turn-on of semiconductor devices. The variation in DC and grid voltages are inputs to the algorithm as n operating points.
1) Equality constraint on power transfer: The constraint ensures that the selected design point vector, \vec{x}_{d}, and control variables' vector, z, results in a power transfer defined by the k-th point on the AC line cycle. It can be calculated using Eqs. (1) and (2).

$${P}_{inst} ( {\vec{x}}_{d} , \vec{x} , {V}_{d c , k} , {v}_{g , k} ) - {P}_{inst , k} = 0 \qquad ( 8 )$$

2) Inequality constraints on control variable vector The constraint ensures that the control variables remain within the physical boundaries and limits of the control platform. In addition, the average power over switching period at the peak of the AC line cycle is less than the maximum possible power transfer through the converter.

$$3.6 ° \leq ϕ \leq 90 ° \qquad ( 9 )$$

$$0.01 \leq {d}_{1} \leq 0.5$$

$$0.01 \leq {d}_{2} \leq 0.5$$

$$2 {P}_{o , rated} \leq \frac{N {V}_{d c} {V}_{g , p k}}{{ω}_{s} {L}_{r}} \frac{π}{4}$$

3) Inequality constraints on switching instant currents: The ideal constraint ensures that the semiconductor devices are always turning-on at zero voltage. It can be determined by the switching instant currents listed in Table I for the positive half-cycle of the grid AC voltage. The constraints may be modified to incorporate the effect of device output capacitance in limiting the soft-switched region of the DAB converter.

$${I}_{{Q}_{1}} \leq 0 ; {I}_{{Q}_{2}} \geq 0 \qquad ( 10 )$$

$${I}_{{Q}_{5}} \geq 0 ; {I}_{{Q}_{6}} \leq 0$$

Comparison of results. The parameters and ratings of the two designs shown previously are presented in Table 1l, along with the conventional designs. The design 1 results in minimum transformer VA rating and combined total VA rating, whereas design 2 results in minimum RMS current. Moreover, the design 2 also results in lower peak current rating of the BiDFET-side bridge. In comparison to the conventional designs, the transformer and the high frequency inductor are up to 14% and 36% smaller, respectively. Moreover, the attenuation needed by the DC and AC side filters is 30-50% smaller in case of optimized designs.

TABLE II
Comparison of component ratings designed using proposed methods with the conventionally optimized designs.

| | Transformer parameters | | | | | | | | | Capacitor currents^{§} | |
|---|---|---|---|---|---|---|---|---|---|---|---|
| Design | Turns- | VA | Inductor parameters | | Total combined | RMS current | | Peak current | | DC- | Grid- |
| strategies | ratio | rating | Lᵣ | LᵣIₚₖI_{RMS} | VA rating (6) | Prim. | Sec. | Prim. | Sec. | side | side |
| Design 1 | 400/320 | 3.3 kVA | 31.5 μH | 8.0 mJ | 7.1 kVA | 8.3 A | 10.5 A | 19.3 A | 24.3 A | 5.4 A | 5.5 A |
| Design 2 | 400/354 | 3.5 kVA | 36.2 μH | 6.6 mJ | 7.4 kVA | 8.7 A | 9.8 A | 16.5 A | 18.6 A | 5.8 A | 5.1 A |
| Design 1^{†} | 400/294 | 3.8 kVA | 54.0 μH | 18.1 mJ | 8.8 kVA | 9.4 A | 12.8 A | 19.2 A | 26.1 A | 7.5 A | 9.8 A |
| Design 1^{‡} | 400/294 | 3.4 kVA | 54.0 μH | 16.4 mJ | 7.9 kVA | 8.5 A | 11.6 A | 19.2 A | 26.1 A | 6.1 A | 8.1 A |

^{†}Conventional design optimized for minimum combined total VA rating considering single-phase shift (SPS) operation.
^{‡}Conventional design operated with advanced modulation schemes [6], [15] to achieve optimal secondary-side RMS current.
^{§}Grid-side capacitor current calculated assuming 5% THD in grid current.

### Harmonic Current Computation Algorithm and Filter Design

Harmonic current computation algorithm. The RMS value of the high frequency current, iᵣ, is derived from the switching instant currents of Table I using an algorithm reported in “Exact Solution of ZVS Boundaries and AC-Port Currents in Dual Active Bridge Type DC-DC Converters” by S. S. Shah et al. (IEEE Transactions on Power Electronics, vol. 34, no. 6, pp. 5043-5047, June 2019.). Here, the following algorithm computes the RMS current at the line frequency AC and DC ports of the converter and design the respective filters.
Consider the switching events and semiconductor currents at turn-on instants, I_{Q1}, I_{Q2}, I_{Q5} and I_{Q6}, as expressed in Table I for positive half-cycle of the grid voltage. Note from FIG. 3 that the corresponding high-side device turns on at t_{Qx} with current I_{Qx}.

$${t}_{{Q}_{x}} = \frac{θ}{2 π} {T}_{s} , \qquad ( 11 )$$

$$∀ x ∈ \{ 1 , 2 , 5 , 6 \} ; θ ∈ \{ \frac{π}{2} \pm π {d}_{1} , \frac{π}{2} + ϕ \pm π {d}_{2} \}$$

where Ts is the period of the AC grid voltage.
Sort the above four switching ‘events’ in chronological order (as ‘evₓ’) to find vertices of the piece-wise linear waveform of AC current:

$$\{ {I}_{{t}_{ev 1}} , {I}_{{t}_{ev 2}} , {I}_{{t}_{ev 3}} , {I}_{{t}_{ev 4}} \} ∈ \{ {I}_{{Q}_{1}} , {I}_{{Q}_{2}} , {I}_{{Q}_{5}} , {I}_{{Q}_{6}} \} at \qquad ( 12 )$$

$$\{ {t}_{ev 1} , {t}_{ev 2} , {t}_{ev 3} , {t}_{ev 4} \} ∈ \{ {t}_{{Q}_{1}} , {t}_{{Q}_{2}} , {t}_{{Q}_{5}} , {t}_{{Q}_{6}} \}$$

For the DC port: compute the RMS value of each j-th piece-wise linear element appearing between t_{Q1} and t_{Q2} in Eq. (13) using the sorted events of Eq. (12). Similarly, for the grid-side AC port, the RMS value of each j-th piecewise linear element appearing between t_{Q5} and t_{Q6} is also computed.

$${I}_{R MS , j} = \sqrt{\frac{2}{3} ( {I}_{{t}_{ev ( j + 1 )}}^{2} + {I}_{{t}_{evj}}^{2} + {I}_{{t}_{ev ( j + 1 )}} {I}_{{t}_{evj}} ) \frac{{t}_{ev ( j + 1 )} - {t}_{evj}}{{T}_{s}}} \qquad ( 13 )$$

Compute the RMS currents at the DC and line frequency AC ports as shown in Eq. (14). The RMS value of the nonfundamental component of the currents are shown in Eq. (15).

$${I}_{d c - port , R MS} = {( \sum {I}_{R MS , j}^{2} )}^{1 / 2} \qquad ( 14 )$$

$${I}_{lfac - port , R MS} = {( \sum {I}_{R MS , k}^{2} )}^{1 / 2}$$

$$\begin{matrix}where , & j = \{ j \vert j ∈ [ {ev}_{j} ≡ {Q}_{1} , {ev}_{j + 1} ≡ {Q}_{2} ) ] \} \\ & k = \{ j \vert j ∈ [ {ev}_{j} ≡ {Q}_{5} , {ev}_{j + 1} ≡ {Q}_{6} ) ] \}\end{matrix}$$

$${I}_{d c - port , h , R MS} = \sqrt{{I}_{pv}^{2} - {I}_{R MS , d c - port}^{2}} \qquad ( 15 )$$

$${I}_{lfac - port , h , R MS} = \sqrt{{I}_{R MS , lfac - port}^{2} - {I}_{g , R MS}^{2}}$$

where I_{dc-port,RMS} is the DC port RMS current and I_{lfac-port,RMS} is the low frequency AC grid port RMS current.

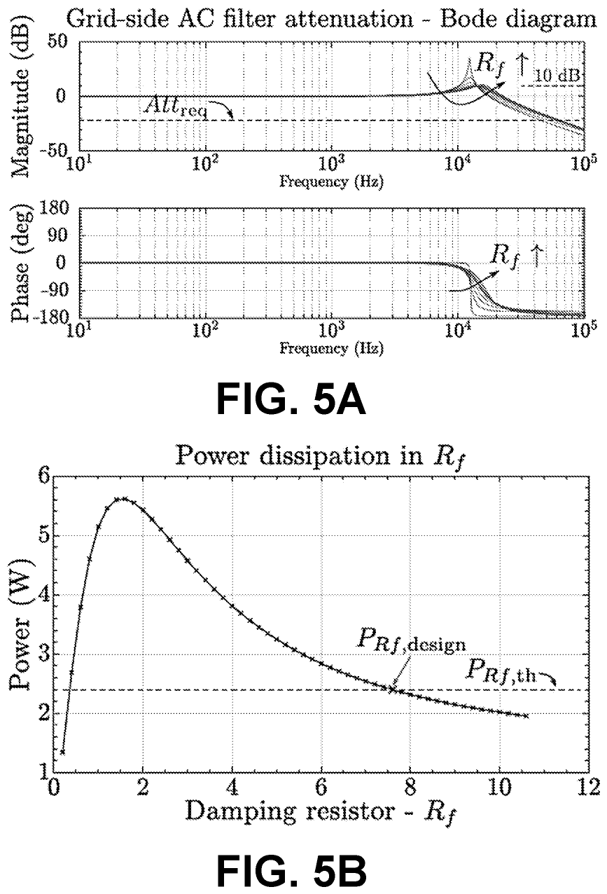

Grid-side filter design. The grid-side filter attenuates the switching frequency harmonics generated by the AC/DC DAB, and its specification is computed based on a THD requirement of 5%. A first-order (capacitor) C-filter consumes unacceptable fundamental frequency reactive power to achieve the required attenuation. Therefore, a second-order (capacitor-inductor) CL-filter with parallel (resistor-capacitor) R_{f}−C_{b} damping branch can be designed on the grid-side port of the monolithic SiC-BiDFET based bridge. Its attenuation transfer function is given in Eq. (16).

$${Att}_{req} = \frac{{THD}_{req} \cdot {I}_{g , R MS}}{{I}_{lfac - port , h , R MS}} and \frac{{I}_{g}}{{I}_{lfac - port}} = \frac{1}{{sL}_{f}} [ {sL}_{f} \vert \vert \frac{1}{{sC}_{f , eff}} ] \qquad ( 16 )$$

$$where , {C}_{f , eff} = {C}_{f} + \frac{{C}_{b}}{{sC}_{b} {R}_{f} + 1}$$

where THD_{req} is the total harmonic distortion requirement, I_{g} is the AC grid current, C_{f,eff} and L_{f} are the effective filter capacitance and inductance, and C_{b} and R_{f} are the damping branch capacitance and resistance. A power factor of 0.999 at the line frequency (ω_{L}) can be assumed and the total capacitance value can be constrained by its reactive power consumption. The filter is designed in FIGS. 5A and 5B for attenuation exceeding Att_{req} of Eq. (16) at twice the switching frequency, peak magnitude of 10 dB at the filter resonant frequency and power loss in the damping resistor to be less than 0.1%. FIG. 5A shows a frequency response plot of the attenuation of the CL-filter and FIG. 5B shows power loss in the damping resistor, R_{f}.

The power loss in the damping resistor, R_{f}, is due to the fundamental frequency component and switching frequency components. Assuming all the high frequency harmonic current through the damping branch is at twice the switching frequency (2ωₛ), the current through R_{f} can be expressed as in:

$${I}_{{R}_{f}} = \frac{{I}_{lfac - port , h , R MS}}{{C}_{f , eff} {\vert}_{2 {ω}_{s}}} \frac{{C}_{b}}{( j 2 {ω}_{s} ) {C}_{b} {R}_{f} + 1} + \frac{{V}_{g , R MS} \cdot ( j {ω}_{L} ) {C}_{b}}{( j {ω}_{L} ) {C}_{b} {R}_{f} + 1} \qquad ( 17 )$$

The power loss with changing R_{f} is plotted in FIG. 5B using Eq. (15), and the filter impedance at 2ωₛ and ω_{L}.

DC-side filter design. At the DC port, the converter current contains second harmonic of the line frequency and the switching frequency harmonics, primarily at 2ωₛ. The second harmonic component of the line frequency is present in any single-phase converter system due to instantaneous power equivalence at its input and output ports, and is directly dependent on the power transfer to or from the grid. Similarly, the even harmonic components of the switching frequency are also present at the DC port and are dependent on the power transfer through the high frequency AC link. The harmonic currents through the DC-side filter capacitance are expressed in Eq. (18).

$${I}_{d c - port , 2 {ω}_{L} , R MS} = \frac{{P}_{o , rated}}{\sqrt{2} {V}_{d c}} \qquad ( 18 )$$

$${I}_{d c - port , hf , R MS} = \sqrt{{I}_{d c - port , h , R MS}^{2} - {I}_{d c - port , 2 {ω}_{L} , R MS}^{2}}$$

The filter capacitance ensures that the total peak-to-peak voltage ripple is within 5% of the nominal DC voltage of Eq. (19).

$$Δ {V}_{d c , pp} = \sqrt{{( Δ {V}_{d c , pp , 2 {ω}_{L}} )}^{2} + {( Δ {V}_{d c , pp , 2 {ω}_{s}} )}^{2}} \qquad ( 19 )$$

The capacitance required to attenuate the respective low and high frequency components are expressed in Eq. (20).

$${C}_{bulk} = \frac{2 \sqrt{2} \cdot {I}_{d c - port , 2 {ω}_{L} , R MS}}{2 {ω}_{L} \cdot Δ {V}_{d c , pp , 2 {ω}_{L}}} \qquad ( 20 )$$

$${C}_{hf} = \frac{2 \sqrt{2} \cdot {I}_{d c - port , hf , R MS}}{2 {ω}_{s} \cdot Δ {V}_{d c , pp , 2 {ω}_{s}}}$$

The proportion of high frequency currents through the bulk capacitance is determined by the board layout and parasitic inductance. The overall capacitance requirement, therefore, is also dependent on the current capabilities of the available component selection at the low and high frequencies.

### Hardware Prototype and Experimental Results

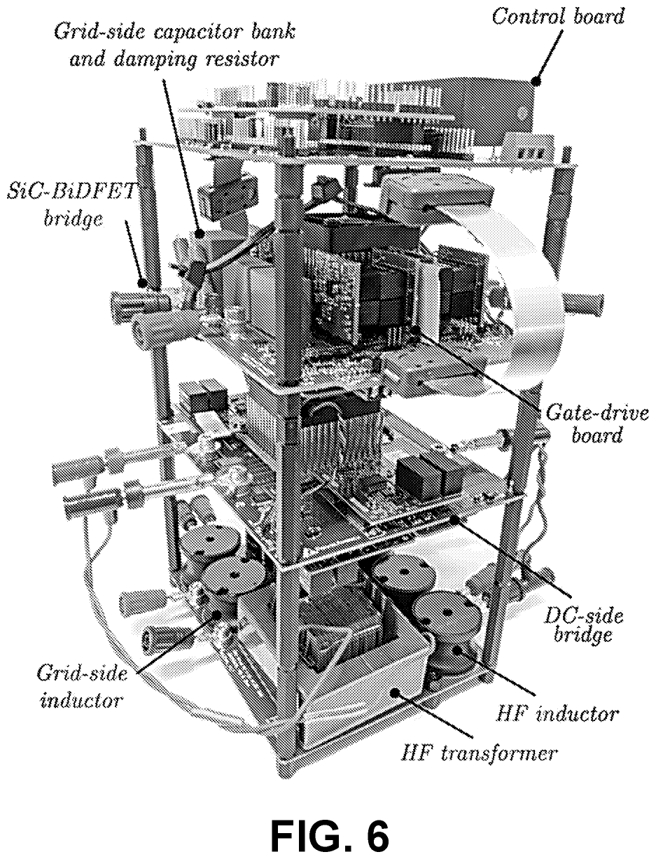

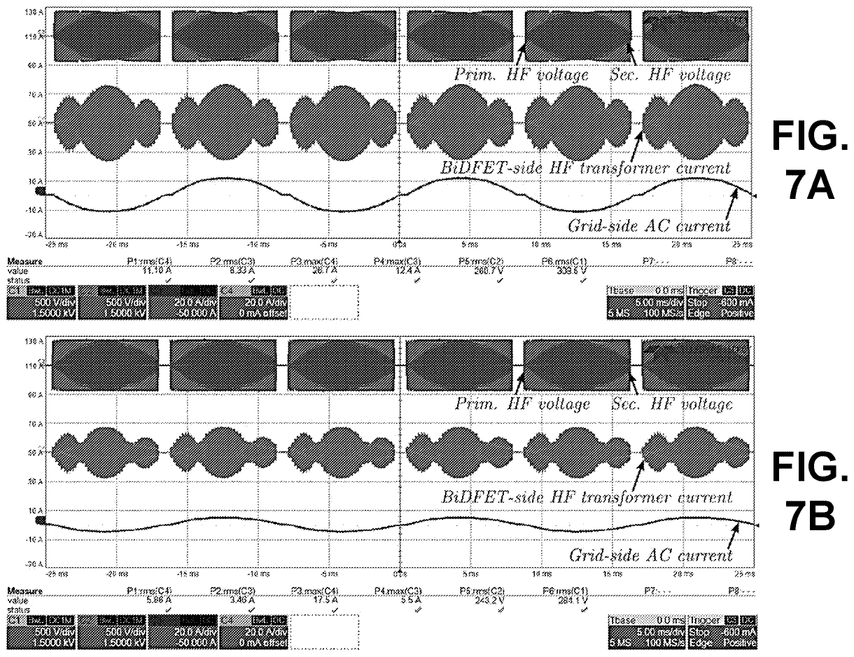

Description of the hardware prototype. The design optimization process with minimum combined total VA rating, harmonic current computation algorithms and the filter design results in a hardware prototype system with parameters listed in Table III. FIG. 6 is an image of the hardware prototype of the 2.3 kW, 400 V to 277 VRMS AC/DC DAB converter based on monolithic SiC-BiDFET. It utilizes 650 V GaN Systems' semiconductor devices on the DC-side, and 1200 V monolithic SiC-BiDFET on the AC-side of the converter. The high frequency AC link comprises of a 3.3 kVA transformer and two series connected 15 pH inductors (e.g., Bourns' 1140-150K-RC). The transformer uses a 16 AWG stranded wire wound on a E70 ferrite (3C95) core. Its peak flux density is 150 mT when a 400 V full square wave voltage is applied across its primary-side terminals. The estimated core and winding loss at 50 kHz and full load are 11 W and 25 W, respectively. In addition, the net winding resistance of the high frequency inductors at 50 kHz is 0.2Ω. The DC-side filter capacitor bank comprises of eight 500 V, 0.6 pF TDK Ceralink capacitors and four 500 V, 330 pF KEMET aluminum electrolytic capacitors. On the grid-side, the capacitor bank comprises of 350 VRMS film capacitors: two 1 pF TDK capacitors for the main filter branch and a 2.2 pF capacitor for the damping branch. The damping resistor is formed by two parallel 15Ω, 10 W axial resistors. The grid-side inductor comprises of two series connected 18 pH inductors. TABLE III System parameters from the design process.

TABLE III
System parameters from the design process.

| Parameter | Variable | Value | |
|---|---|---|---|
| Nominal power | P_{o, rated} | 2300 | W |
| Nominal DC voltage | V_{dc} | 400 | V |
| Nominal AC voltage | V_{g, RMS} | 277 | V |
| Switching frequency | fₛ | 50 | kHz |
| HF inductance | Lᵣ | 31.5 | μH |

| | | |
|---|---|---|
| Transformer size | VA, 1:N | 3.3 kVA, 19/15 |
| Grid-side CL filter | C_{f}, L_{f} | 2.0 μF, 36 μH |
| Damping branch | C_{b}, R_{f} | 2.2 μF, 7.5 Ω |
| DC-side filter | C_{bulk}, C_{hf} | 1.3 mH, 4.8 μF |

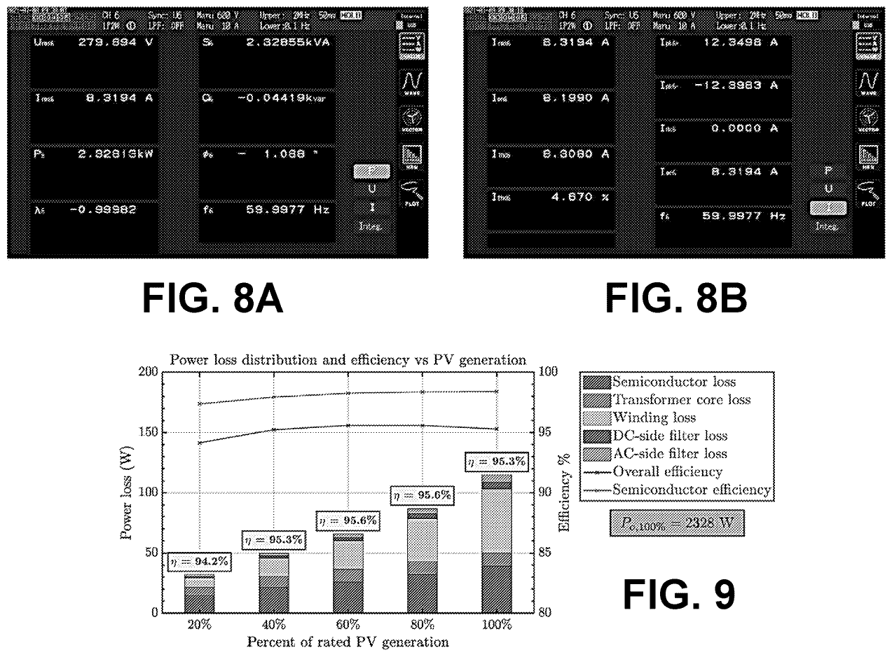

Results and discussion. The prototype of the AC/DC DAB converter was tested with a DC power supply connected on the PV or the DC-side with progressively increasing load. The operating waveforms of the converter at 100% and 40% load are shown in FIGS. 7A and 7B, respectively. The operating waveforms of the 2.3 kW AC/DC converter are with an input DC voltage of 400 V and an output voltage of 277 V_{RMS}. In the figure, the high frequency voltages on both sides of the transformer-inductor arrangement are shown along with the secondary-side transformer current and the grid-side AC port current. The transformer RMS and peak current were in agreement with the optimized design shown in Table II. The ‘dead-time’ near the zero crossing of the AC output current enables safe commutation of the constituent FETs of the BiDFET. Even with the zero-crossing distortion, the power factor and the current THD at 100% load, as measured at the converter output with the Hioki Power Analyzer PW6001, were 0.999 and 4.7%, respectively. FIGS. 8A and 8B show the power factor and current THD, respectively, at 100% load.

FIG. 9 illustrates the overall input to output port efficiency with operating load ranging from 20% to 100%. In addition, the loss distribution in different components was estimated using the currents predicted through models derived in the previous sections. These include the loss in the transformer core, transformer and high frequency inductor winding, DC side filter capacitor (high and low frequency losses), and AC side filter capacitor. Assuming other loss as negligible, the semiconductor loss and the corresponding efficiency was also estimated. FIG. 9 illustrates the estimated power loss distribution and semiconductor efficiency against the operating load range.

A process to optimize the design of a single-phase AC/DC DAB converter utilized for interfacing a PV-string to the AC grid for commercial, industrial, or residential applications has been presented. The disclosed optimization algorithm leverages the three degrees-of-freedom (φ, d₁, d₂) and optimizes the high-frequency RMS current, size of magnetic elements and the soft-switched region of the converter. Unlike those reported in literature, it incorporates all modulation strategies and operating modes of the AC/DC DAB converter, constrained only by the limits of the controller. It has been shown to have a clear advantage in terms of transformer, inductor, RMS current and filter ratings when compared to conventional design methods. Further, an algorithm to compute the harmonic ripple currents at the DC and line frequency AC ports has been presented. The algorithm aids in the design of the grid-side and DC-side filters which is also presented. Finally, experimental results on a hardware prototype demonstrate the validity of the design. The current THD, overall efficiency and semiconductor efficiency at full load (2.3 kW) and voltage with 50 kHz switching frequency are 4.7%, 95.3% and 98.4% respectively.

The disclosed methodology allows transfer of power from a DC/low-frequency bipolar/unipolar voltage/current to high frequency AC voltage/current. A system of electronic circuits and software is presented that can be used in many applications that utilize BiDFET devices. The disclosed system has advantages in terms of reduced semiconductor count, improved efficiency, and reliability, along with many features for converter operation including gate-drivers, interlocking mechanism or circuitry, sensor and hardware protection, short-circuit fault protection, converter fault protection and control software.

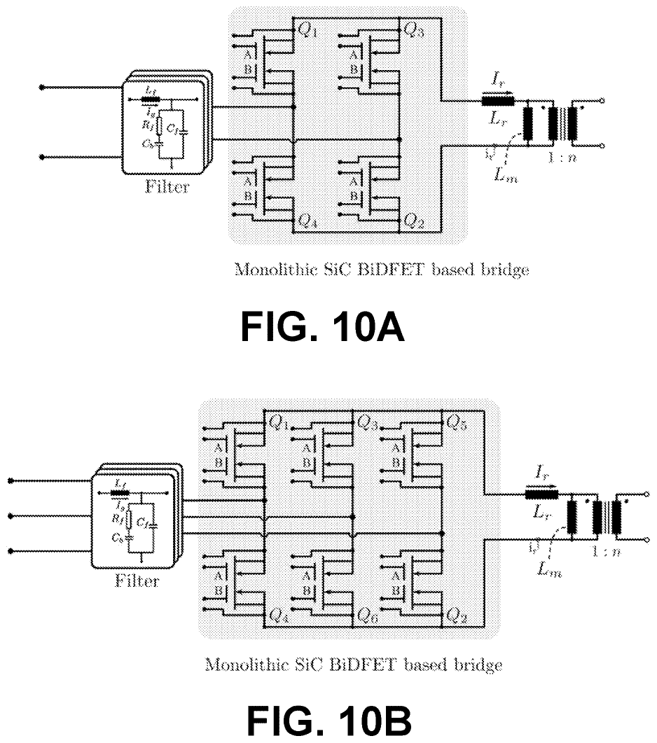

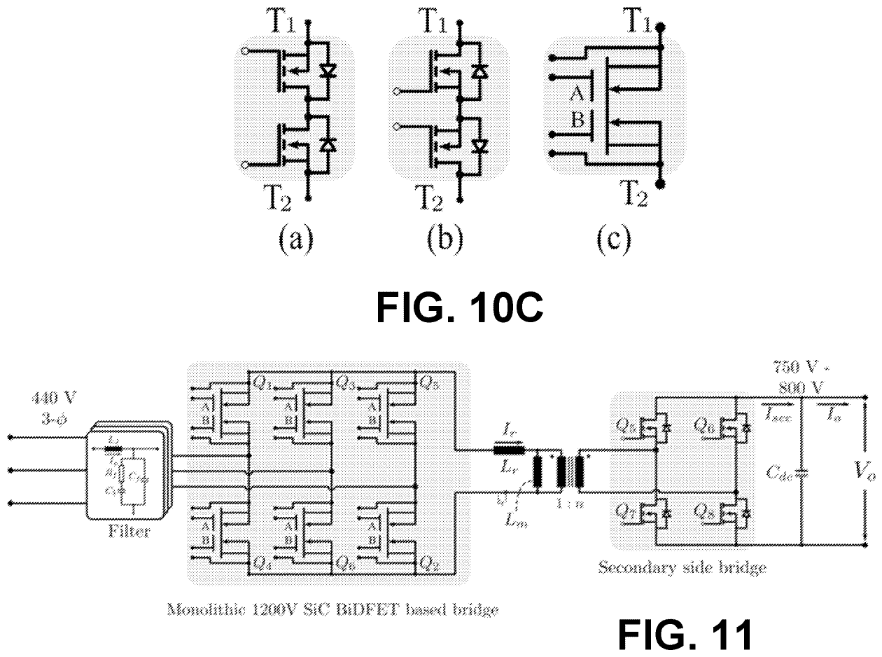

The structure can comprise monolithic SiC BiDFET and can use its capability of four quadrant operation to the reduce the number of semiconductors in the system. The structure configuration may be of two types: a) single-phase power circuit as illustrated in FIG. 10A, and b) three-phase power circuit as illustrated in FIG. 10B. Both these configurations interface high frequency AC square wave voltage/current (henceforth, called HFAC port) with the low-frequency single-phase/three-phase AC voltage or DC voltage (henceforth, called LF port).

The LF port can be connected to a motor drive, single-phase grid or three-phase grid with/without a filter configuration. Similarly, the HFAC port may be connected to a high frequency source or load, either directly or through a combination of high frequency transformer-inductor-capacitor arrangement. The structure can include a) current sensor(s) at the LF port, and/or b) voltage sensor(s) at the LF port. It may also include current sensor(s) at the HFAC port. The structure includes gate-driver(s), short circuit protection, converter fault protection, interlocking mechanism(s), and/or controller for operating the system. The structure can be connected in parallel or series at the LF port for increasing the current or voltage rating, respectively.

Four-quadrant switches can be implemented with back-to-back connected MOSFETs in (a) common-drain (CD-FQS) or (b) common-source (CS-FQS) configurations as shown in FIG. 10C. CS-FQS has been shown to have higher turn-on losses and lower turn-off losses relative to CD-FQS. While CD-FQS can be manufactured with fewer steps on epitaxially grown drift regions, the CS-FQS needs a lesser number of isolated gate-driver power supplies due to the common-source node being a reference for the two gate drives.

Four-quadrant switches can also be (c) BiDFET devices as shown in FIG. 10C, which can be fabricated as a monolithic four-terminal switch comprising two internal 1.2 kV 4H—SiC JBS-diode-embedded-power MOSFETs (JBSFETs) connected in a common-drain configuration. A monolithic four-quadrant switch enables a lower number of devices, lower inductance, lesser number of wire bonds, lesser number of packaging steps, narrower temperature cycling, and consequently more reliable, power-dense modules and converters.

The structure uses BiDFET technology to reduce the count of semiconductors. This can improve efficiency by reducing switching energy losses and, potentially, conduction losses. In addition, the number of bond-wire sets in the system are reduced by 50%, which can reduce a major cause of failures. FIG. 1 illustrates an example of a single-phase structure in solar PV energy generation. Galvanically isolated, grid connected PV solar inverter using 4-QPS devices (e.g., BiDFET or bidirectional FET). For example, it can also be used for EV chargers and data-center power supplies. FIG. 11 illustrates an example of a three-phase AC to DC, galvanically isolated power conversion using 4-QPS or BiDFET. For example, it can be used for isolated DC voltage generation, solar PV energy generation, electric vehicle chargers. The structures can include one or more sensors, one or more gate-driver, short circuit protection, overvoltage protection, converter fault protection, interlocking mechanism or circuitry and controller.

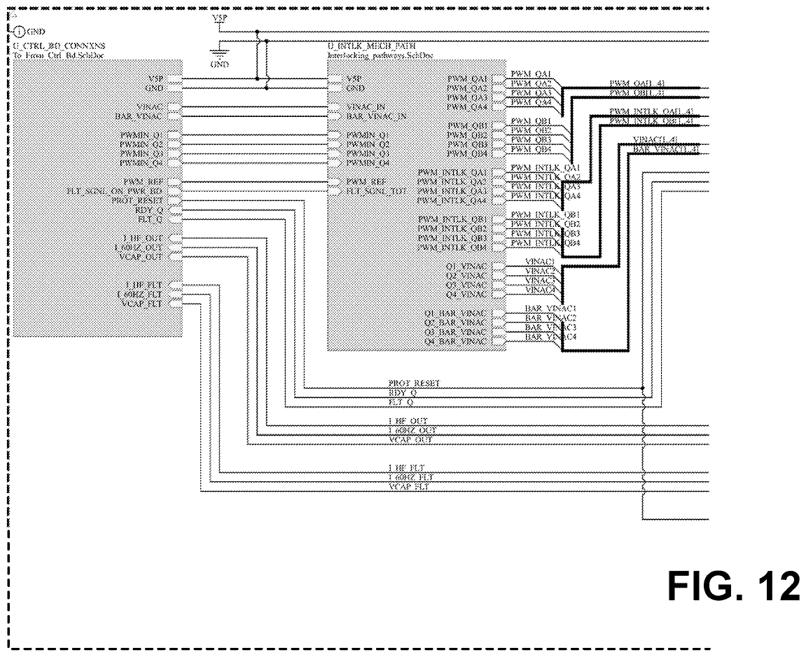

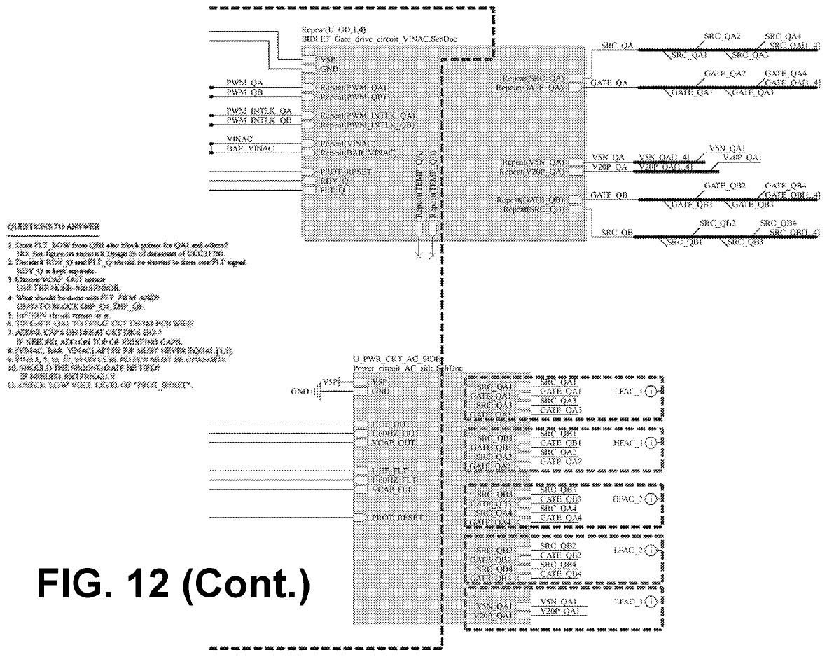

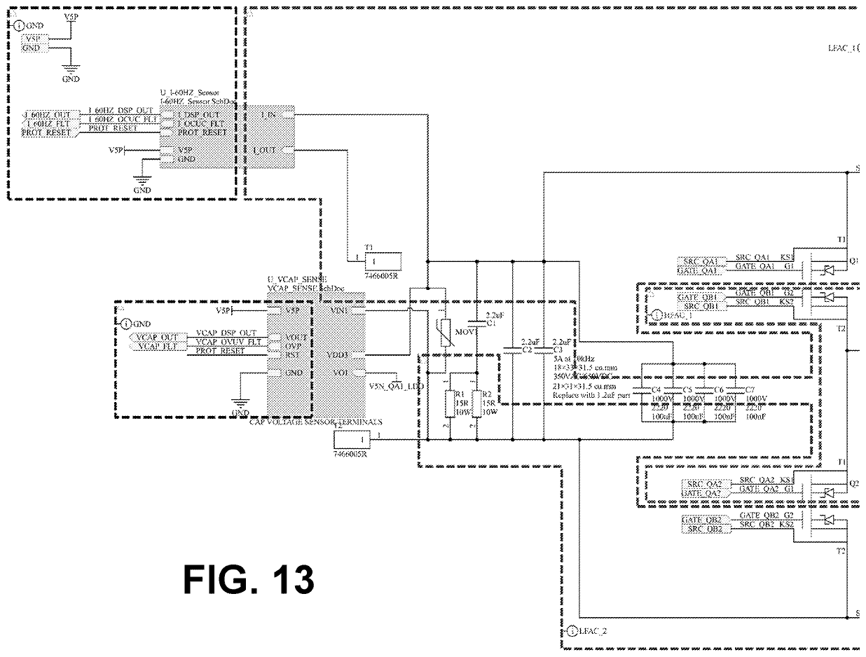

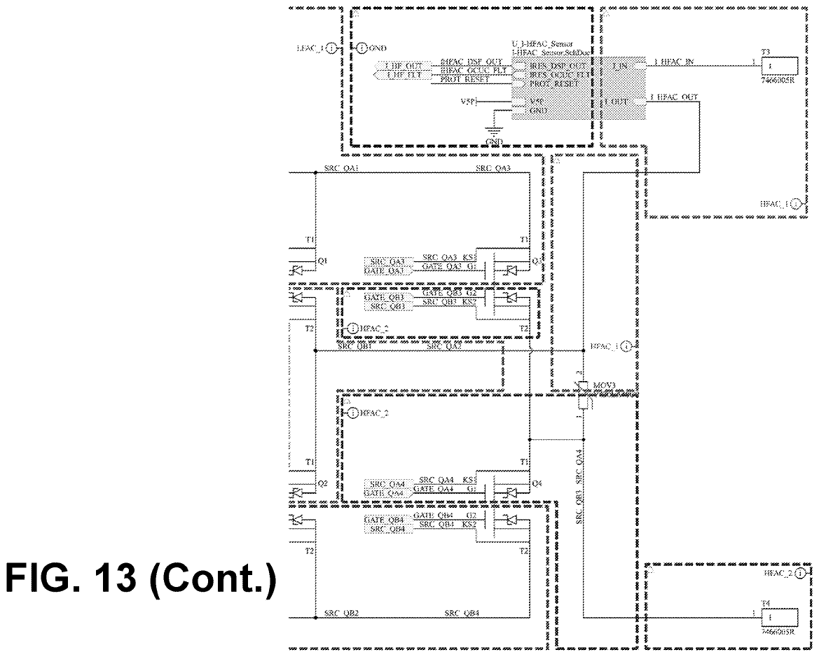

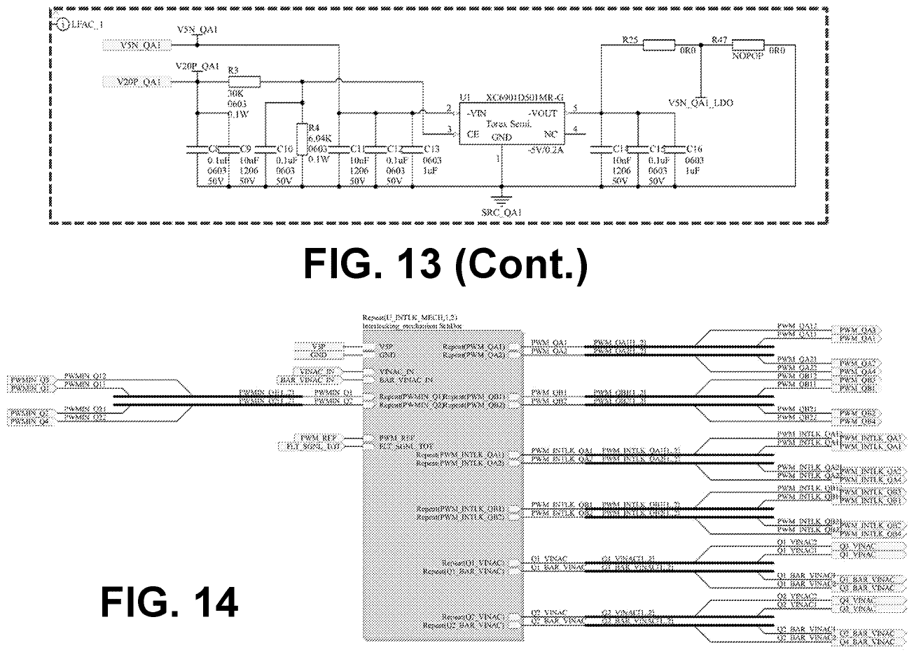

FIG. 12 illustrates an example of converter circuitry, FIG. 13 illustrates an example of power circuitry comprising sensors and hardware protection, and FIG. 14 illustrates an example of interlocking circuitry to ensure correct constituent FET is switching while the other is conducting in a 4-QPS. This circuit is for a full-bridge circuit. The structure includes a power circuit as shown in FIG. 13 that includes the power circuit (single-phase example shown in FIG. 13), current sensor on the LF (I-60HZ_Sensor.SchDoc) and HFAC port (I-HFAC_Sensor.SchDoc), and voltage sensor (VCAP_SENSE.SchDoc) on the LF port. The sensor circuits also include hardware fault protections.

The gate-driver can ensure proper isolated driving signals at correct isolated voltage levels to the BiDFET (BiDFET_Gate_Drive_Circuit_VINAC.SchDoc in FIG. 12). The short circuit protection can ensure that the capacitors do not get shorted through the BiDFETs (in BiDFET_Gate_Drive_Circuit VINAC.SchDoc in FIG. 12). The overvoltage protection can ensure that in case the HF inductor currents are interrupted, the semiconductors and other components in the system are not exposed to high voltages (in Power_circuit_AC_side.SchDoc in FIGS. 12 and 13). The converter fault protection is designed in hardware and software (in To_From_Ctrl_Bd.SchDoc in FIG. 12) to ensure nominal operation of the converter and appropriate response in case of faults.

The interlocking mechanism or circuitry (in Interlocking_pathways.SchDoc in FIGS. 12 and 14) ensures appropriate semiconductors are turning on and off depending on the LF port voltage polarity. It also mitigates risk of capacitor shorting or inductor current interruption that can trigger protections of the gate drivers and short circuit protection above. The controller (in To_From_Ctrl_Bd.SchDoc in FIG. 12) can ensure correct modulation signals are supplied to the interlocking mechanism or circuitry. It takes input from the sensors and determines appropriate modulation signals based on the control design.

The gate driver and fault protection of a four-quadrant power semiconductor (4-QPS) device will now be discussed. The gate driver circuit can ensure that out of the two constituent FETs within the 4-QPS device turns-on or off, while the other is always conducting. It is dependent on the polarity of the blocking voltage across the 4-QPS when it is turned-off. In addition, there is also flexibility to control the two constituent FETs independent of each other. The fault (short-circuit) protection circuit, on the other hand, can detect if the semiconductor switching is resulting in a short circuit and can take action to remove such condition.

The fault protection can also be used with reverse blocking IGBT (RB-IGBT) and any 4-QPS with anti-parallel IGBTs/MOSFETs/SiCFETs/GaNFETs. Therefore, this can be applied to power semiconductors fabricated with all materials, such as silicon, silicon carbide (SiC), gallium nitride (GaN), gallium oxide (GaO), and others.

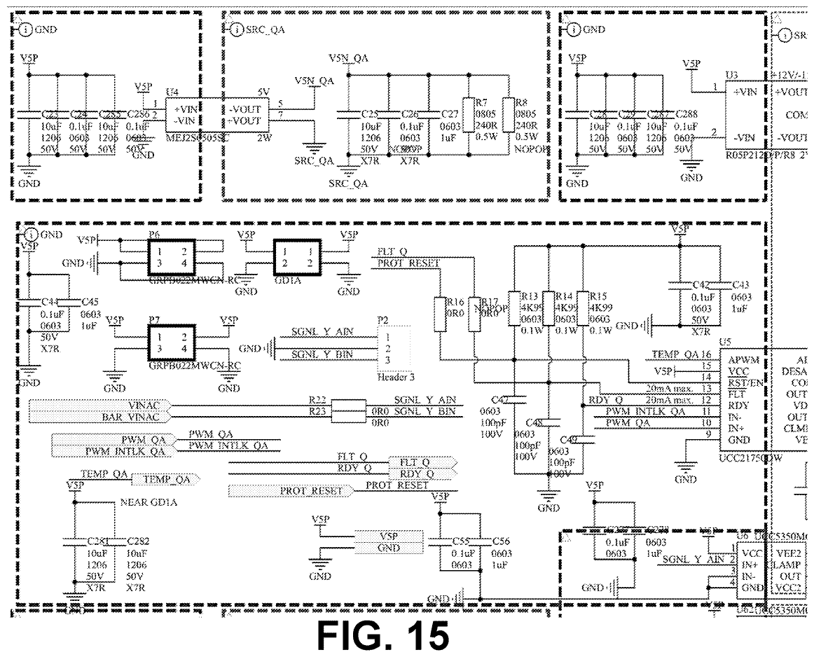

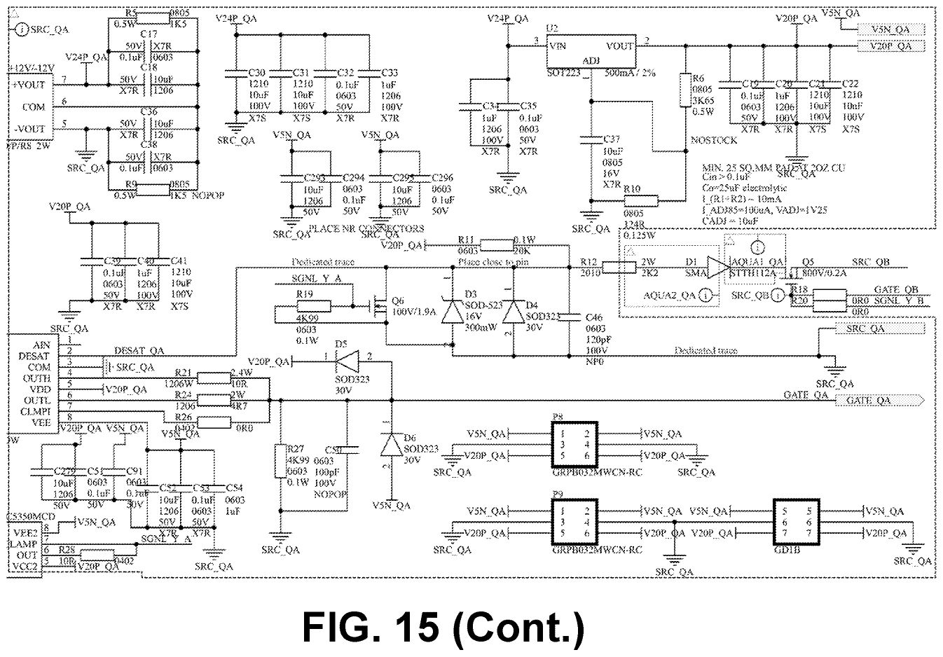

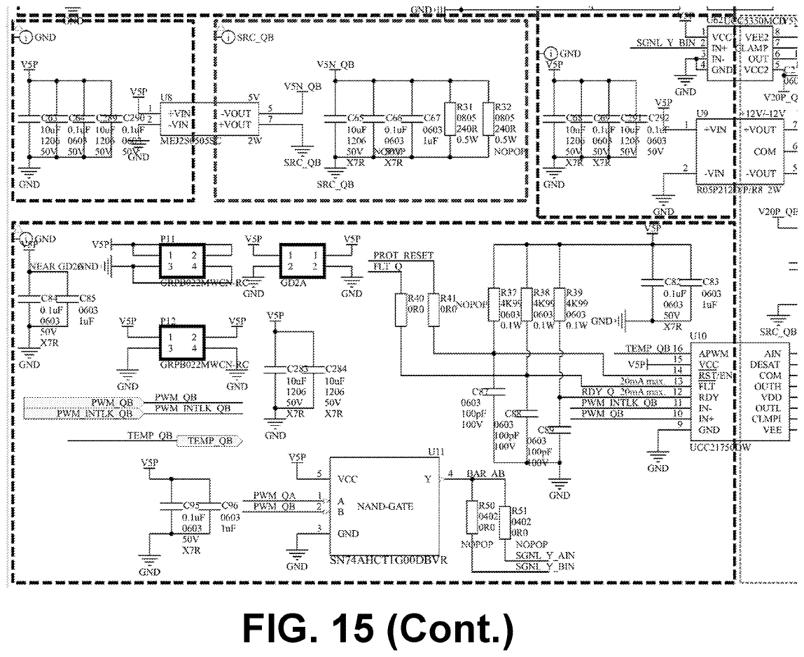

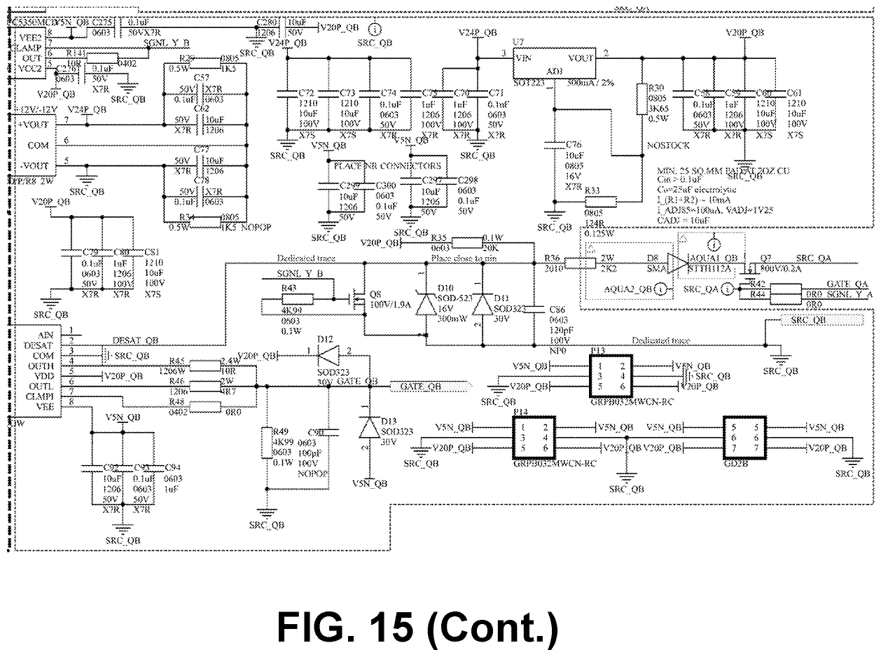

Gate-driver circuit. FIG. 15 illustrates an example of a gate driver for a device, which can ensure that the device can independently or codependently conduct and switch the constituent FETs/switches of the 4-QPS device. Any power converter developed using the 4-QPS devices can utilize such a gate driver for chopping source voltage and current into controlled high frequency forms, which can then be filtered to generate the desired voltage and current at its output terminals.

The circuits reported in the prior art cannot be used for 4-QPS devices as it will result in breaking of inductor current or shorting of capacitor terminals. It occurs due to inability of the gate-drivers to account for the polarity of the blocking voltage across the 4-QPS. The disclosed gate driving circuit can, depending on the blocking voltage across the 4-QPS, ensure: a) that one of the constituent FET conducts continuously through the switching period and b) the other constituent FET switches/modulates as determined by a control algorithm. Such function allows use of the semiconductor channel instead of the anti-parallel diode resulting in significant improvement in efficiency.

The gate-driver circuit of FIG. 15 also has flexibility to independently control the constituent FETs of the 4-QPS. Such action may become important when a) the blocking voltage across the 4-QPS is flipping or reversing, or b) the control algorithm has detected a fault (other than device short-circuit) and is forcing the converter to trip. It can ensure that the inductor currents are not broken instantaneously which can cause severe over-voltages throughout the system.

The disclosed gate-driver circuit comprises two sub-circuits A and B, and a few miscellaneous sub-circuits:
A. Isolated power supplies: Two voltage rails corresponding to the turn-on and turn-off voltage generated using typical isolated power supply designs that can include linear regulators per constituent FET of the 4-QPS.
B. Isolated gate-driving signals: Two signals are used for nominal operation of the 4-QPS: a low-frequency signal describing the polarity of the blocking voltage (typically, a common signal to all 4-QPS in one phase) and a high frequency PWM signal per 4-QPS generated from the controller. From these two signals, two isolated gate-driving signals can be generated for the full 4-QPS device.
C. Miscellaneous features: Miller clamps to ensure immunity against false turn-on, gate-source pull-down for default-off condition, under-voltage lockouts, and gate terminal clamps for protection against gate-source over-voltages.

Short-circuit fault protection circuit. The power converters enabled by the four-quadrant power semiconductor (4-QPS) devices transfer power from one AC or DC port to a second AC or DC port. The converters can also transfer power in the reverse direction. One of the ports (first or second) will have a capacitance emulating a voltage source. A fundamental need of any power converter is to ‘not short’ the capacitance. Therefore, one and only one 4-QPS connected between the capacitance terminals should be in ON-state. In the case of a failed device (failed short), when the other 4-QPS is turning-on, the capacitor terminals are shorted. The short circuit condition may also occur if the gate-signals to more than one 4-QPS devices between the capacitance terminals are high at the same time; it may occur due to mismatched or unaccounted propagation delays of the gate-driver electronics, or spurious/unintentional turn-on of the OFF-state 4-QPS due to high rate-of-rise of voltage at the switching nodes of the converter.

A protection circuit can be provided that can detect if 4-QPS device switching is resulting in a short circuit of the capacitor terminals. If used with four terminal 4-QPS devices, the circuit reported in the prior art will result in infeasible component ratings. It is because under nominal conditions when the capacitor voltage is negative, there is a direct path for the capacitor current to flow through the clamping and Zener diodes, the blocking diode, and the resistor. The capacitor voltage minus the forward voltage drop of the in-path diodes will appear across the resistor, resulting in tens of Watts of losses; such resistor will have a large physical size infeasible for any application and significantly degrade efficiency and power density.

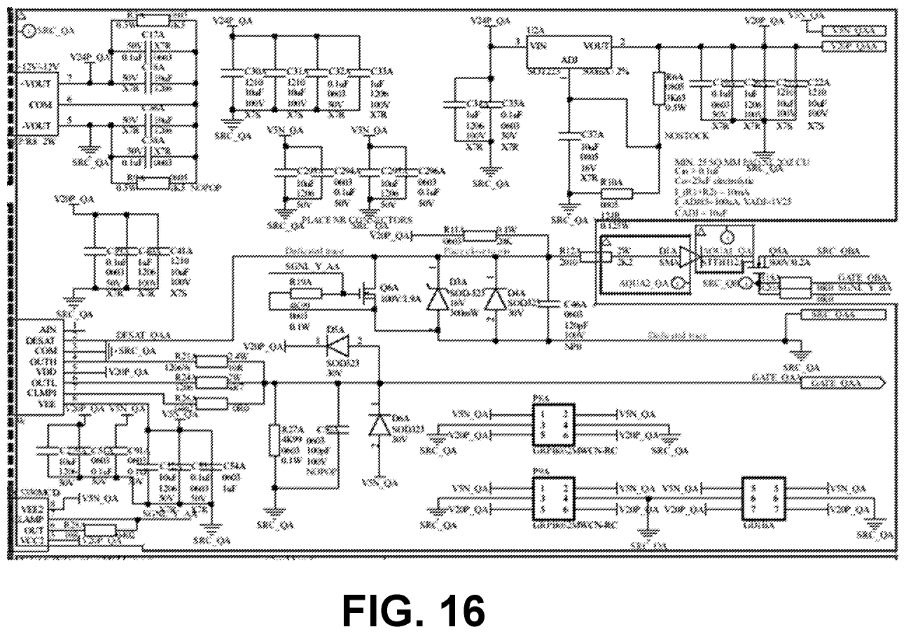

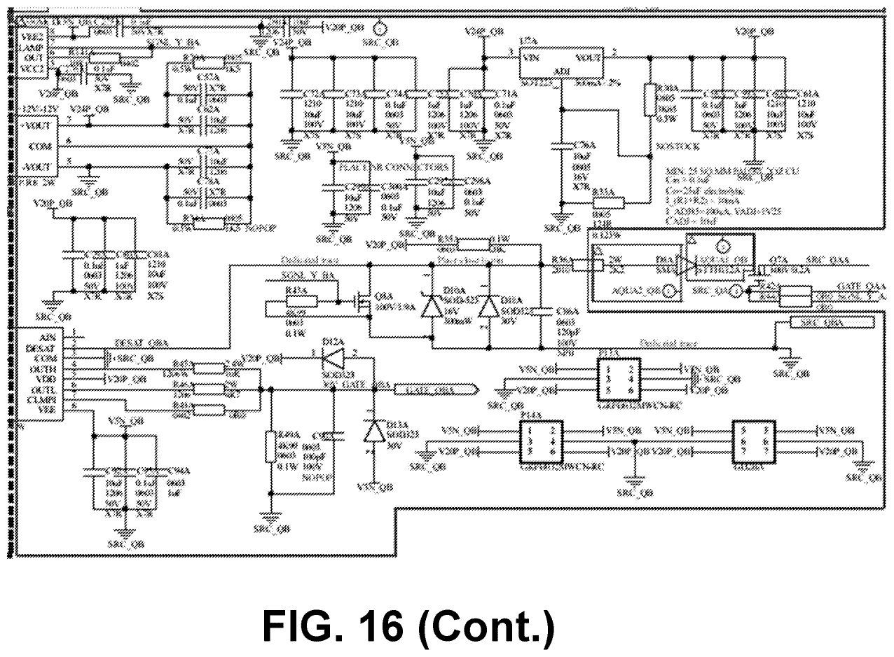

The protection circuit can assure high efficiency operation at nominal operating conditions and can detect short circuit as well as take protection actions. Extremely low current, high voltage auxiliary semiconductor devices such as MOSFET can be used. Depending on the polarity of the capacitor voltage, one auxiliary MOSFET is in OFF-state to block the voltage and prevent it from appearing on the corresponding resistor element. For example, if the capacitor voltage is positive, the MOSFET Q5A will be in OFF-state, while MOSFET Q7A will be in ON-state (see FIG. 16). The gate-signal of the auxiliary MOSFETs may be directly derived from the gate-signals of the 4-QPS or may be independently supplied. Moreover, the arrangement may be employed with existing commercially available gate-driver integrated circuits (ICs) or with independently designed gate-driver circuits.

The present disclosure of the gate-driver and short-circuit fault protection of 4-QPS devices has following features. For the gate-driver:
1. The gate-driver circuit can a) provide isolated power supplies at designated turn-on and turn-off voltages to the two constituent FETs in the 4-QPS, and b) provide driving signals to the 4-QPS based on blocking voltage polarity and operating condition.
2. The circuit can comprise of one or two power supplies per constituent FET of the 4-QPS that generates the turn-on and turn-off voltage. The power supplies can be rated to supply power depending on the maximum switching frequency of the 4-QPS. There are multiple methods to generate the power which may include (but are not limited to) push-pull and flyback converters, linear regulators, and switching regulators.
3. The circuit can also comprise digital isolators (e.g., one each for the constituent FET of the 4-QPS) and routing circuitry. The circuit takes in the high frequency PWM signal from the controller and the blocking voltage polarity signal (generated from the controller or otherwise). It can output two isolated driving signals for the two constituent FETs in the 4-QPS.
4. Within the driving circuit (prior to isolation), an interlocking circuit illustrated in FIG. 14 can also ensure coordination between multiple 4-QPS devices in the circuit disallowing capacitor voltage shorting or inductor current breaking. The coordination, in nominal condition, also ensures that one constituent FET in each 4-QPS is always ON depending on the blocking voltage polarity. Such interlocking circuitry may be devised in hardware, FPGA or CPLD.
   The circuit shown in FIG. 14 is for a full-bridge converter based on 4-QPS. PWM_Q1x and PWM_Q2x are the inputs of the so-called high-side and low-side 4-QPS devices—a pair for each leg ‘x’. VINAC and BAR_VINAC are input signals indicating positive or negative blocking voltage polarity. PWM_QA1, PWM_QB1, PWM_QA2, PWM_QB2 are the final gate-drive output signals to the constituent FETs of the high and low-side 4-QPS devices in one leg. Similarly, PWM_INTLK_QA1/QB1/QA2/QB2 are output signals and flags to direct and indicate proper interlocking during nominal/fault conditions.
5. In a fault condition (other than a device short-circuit fault), when the control algorithm decides to trip the converter, the interlocking circuitry can also coordinate the withdrawal or supply of gate-pulses to ensure safe fault response (i.e., without shorting the capacitor terminals or opening non-zero inductor current).
6. The gate-driver can also include other functions such as Miller clamping, undervoltage lockout, gate-source pull down and gate-terminal overvoltage protection.
   The gate-driver can turn-on or off the constituent FETs of the 4-QPS in a co-dependent manner as well as depending on the polarity of the blocking voltage across the device. Under nominal conditions, it can ensure conduction throughout the switching period for one of the FETs in the 4-QPS, while switch the other FET as per the control algorithm. It can significantly improve efficiency. Under fault conditions and when the blocking voltage polarity is reversing, it may be desired to switch the constituent FETs of the 4-QPS independently. The circuit can allow for such functionality. The circuit can be used to drive 4-QPS based on bidirectional FETs, RB-IGBTs as well as those based on silicon, silicon-carbide (SiC), gallium-nitride (GaN) or any other device technology.

For the short-circuit fault protection:
1. The short circuit protection can detect and resolve a short circuit condition appearing at the semiconductor. It can include a) a hard short circuit condition where the capacitor terminals are effectively shorted through the 4-QPS device, and b) an overcurrent appearing due to the system supplying a higher than rated load.
2. The circuit can comprise a blocking diode (D1A/D8A), blocking MOSFET (Q5A/Q7A), current limiting resistor (R12A/R36A), blanking capacitor (C46A/C86A), protection diodes (D3A, D4A and D10A, D11A) across the blanking capacitor and low voltage discharge switch (Q6A/Q8A). This circuit can be connected across the two power terminals of the 4-QPS.
3. When the blocking voltage across the 4-QPS is positive, MOSFET Q5A can be in an OFF-state and block the system voltage from appearing across the resistor. Similarly, when the blocking voltage across 4-QPS is negative, MOSFET Q7A can be in an OFF-state.
4. The gate pulses to the auxiliary MOSFETs Q5A and Q7A may be through one of three options:
   MOSFET Q5A gate can be supplied through BiDFET-B gate-signal. Similarly, MOSFET Q7A gate can be supplied through BiDFET-A gate-signal.
   MOSFET Q5A and MOSFET Q7A gate-signals can be dependent on the direction of blocking voltage—this variant uses a voltage sensor across the power capacitor terminals, which is typically available for sense/measurement.
   MOSFET Q5A and MOSFET Q7A gate-signals can be derivatives of a voltage signal sensed directly at the power terminals of the 4-QPS device.
5. When the auxiliary MOSFETS Q5A or Q7A is open, the respective low voltage discharge switch Q6A/Q8A should be closed to ensure that the blanking capacitor remains discharged.
6. When the respective protection circuit is activated and the system is under nominal conditions, the blanking capacitor discharges through the blocking diode, blocking MOSFET and the 4-QPS device.
7. Under fault conditions, the blocking diode will be reverse biased, and the blanking capacitor is charged through a source (a current source, voltage source or both). Once the blanking capacitor voltage exceeds a threshold, the short circuit is said to be detected.
8. When the short circuit is detected, the gate signal is ramped down from its high value to negative value in a slow gradient that may be exponential, ramped, in steps or a combination of these.
9. The technique may be implemented on commercially available gate-driver integrated circuits (IC) or through a comparator-based circuit.
   The disclosed short-circuit fault protection can ensure that independent of the direction of blocking voltage, the circuit can safely detect and resolve the short circuit condition on the 4-QPS. The short-circuit fault protection can also be used with RB-IGBTs and 4-QPS with anti-parallel configuration. It can ensure that the system voltage does not appear across the resistor and can ensure the feasibility of its design. The small resistor value allows the use of circuits and ICs which have feasible bias current levels and those which are commonly available in the commercial marketspace. The circuitry can be implemented on commercial gate-driver ICs or through comparator-based circuit. The disclosed arrangement does not require any specialty ICs or other special circuit elements.

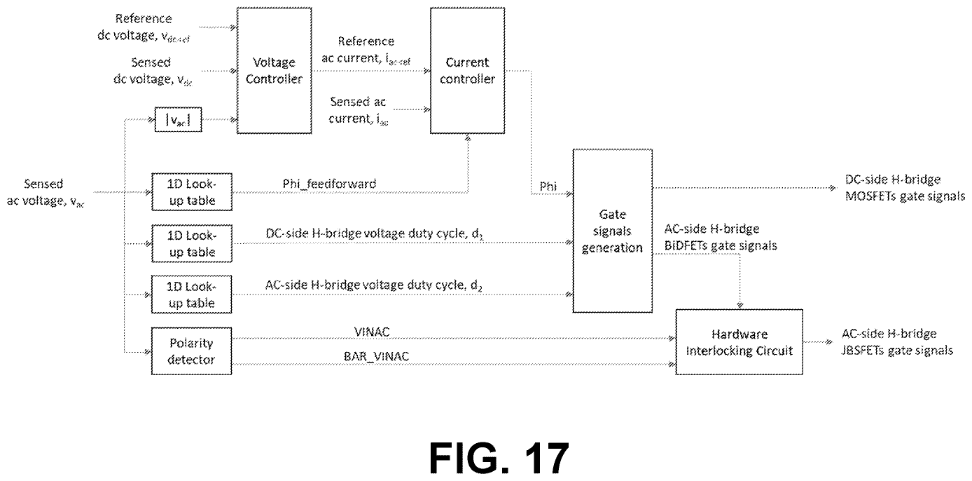

FIG. 17 illustrates a control diagram for a single-phase AC-DC DAB. The voltage controller can generate a reference ac current based upon reference dc voltage, sensed dc voltage, and sensed ac voltage magnitude. The current controller can generate phase angle based upon the reference ac current, sensed ac current, and feedforward angle. Gate signals can be generated based upon the phase angle, DC side bridge voltage duty cycle, and AC side bridge voltage duty cycle. 1D look-up tables can be calculated using the same algorithm explained for converter design and can ensure the ZVS/ZCS operation of all the converter switches. Different look-up tables are utilized for each set of ac voltage peak, dc voltage, and processed power values.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A power converter, comprising:
a first bridge circuit comprising a plurality of bidirectional field effect transistor (BiDFET) devices configured for four quadrant operation;
a second bridge circuit comprising a plurality of switching devices;
a link coupling the first and second bridge circuits; and
control circuitry configured to control operation of the plurality of BiDFET devices of the first bridge circuit and the plurality of switching devices of the second bridge circuit, where the control circuitry comprises a gate-driver configured to provide two isolated driving signals to each BiDFET device, the isolated driving signals causing continuous conductance of a first switch of the BiDFET device though a corresponding switching period and modulates a second switch of the BiDFET device through the corresponding switching period.

2. The power converter of claim 1, wherein the plurality of BiDFET devices comprise monolithic SiC BiDFETs.

3. The power converter of claim 1, wherein the plurality of BiDFET devices comprise back-to-back transistors coupled with a common source or a common drain.

4. The power converter of claim 1, wherein the first bridge circuit is a three-phase bridge circuit.

5. The power converter of claim 1, wherein the first bridge circuit is a single-phase bridge circuit.

6. The power converter of claim 1, wherein the control circuitry comprises interlocking circuitry configured to coordinate switching of the plurality of BiDFET devices preventing capacitor voltage shorting or inductor current breaking.

7. The power converter of claim 6, wherein the interlocking circuitry is configured to coordinate withdrawal or supply of gate-pulses during a trip in response to a fault condition.

8. The power converter of claim 7, wherein the interlocking circuitry coordinates withdrawal of the gate-pulses from the plurality of BiDFET devices to trip the power converter.

9. The power converter of claim 7, wherein the trip is implemented without shorting the capacitor terminals or opening non-zero inductor current.

10. The power converter of claim 1, wherein the control circuitry comprises short-circuit fault protection configured to detect a short-circuit condition and adjust operation of the plurality of BiDFET devices to remove the short-circuit condition.

11. The power converter of claim 1, wherein the power converter is configured for bidirectional power flow via the first and second bridge circuits.

12. The power converter of claim 11, wherein the power converter is utilized to control power flow of an energy storage system.

13. The power converter of claim 1, wherein the power converter is utilized to control power flow of a photovoltaic (PV) solar cell in a solar PV energy application.

14. The power converter of claim 1, wherein modulation of the second switch is based upon polarity of a blocking voltage when it is turned-off.

15. The power converter of claim 1, wherein the gate-driver is configured to independently control the two isolated driving signals.

16. The power converter of claim 1, wherein the gate-driver comprises digital isolators for the isolated driving signals.

17. The power converter of claim 1, comprising a second-order capacitor-inductor (CL) filter at an output of the first bridge circuit, the second-order CL filter configured to attenuate switching frequency harmonics generated by the power converter.

18. The power converter of claim 17, wherein the second-order CL filter comprise a parallel resistor-capacitor (RC) damping branch.

19. The power converter of claim 17, wherein the second-order CL filter maintains a total harmonic distortion of 5% or less.
